(19) United States
(12) Patent Application Publication
(10) Pub. No.: US 2002/0147254 A1
(43) Pub. Date: Oct. 10, 2002

(54) Stable aqueous dispersion of a preformed polymer in concrete and cementatious composites

(76) Inventors: Chan Han, Midland, MI (US); James E. Pate III, Sanford, MI (US); Louis A. Kuhlmann, Greenbush, MI (US); Aleksander J. Pyzik, Midland, MI (US); Ted A. Morgan, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/954,408

(22) Filed: Sep. 17, 2001

Related U.S. Application Data
(60) Provisional application No. 60/236,915, filed on Sep. 29, 2000.

(51) Int. Cl. C08K 3/00

(52) U.S. Cl. 524/2

(57) ABSTRACT

Stable aqueous dispersions of prepolymers or preformed polymers or redisperable powder polymers that are film-forming at processing temperatures of concrete or mortar can be blended with concrete or mortar to impart desirable low water permeability and Ready-Mix truck deliverability to the modified concrete or mortar.

### CROSS-REFERENCE STATEMENT

This application claims the benefit of U.S. Provisional Application No. 60/236,915, filed Sep. 29, 2000.

### BACKGROUND OF THE INVENTION

The present invention relates to a stable aqueous dispersion of a prepolymer or a preformed polymer or a redispersable powder polymer in concrete and cementatious composites. Although concrete is well-established as a low cost structural material, its durability is limited by two significant property weaknesses, namely high permeability (porosity) and low toughness. Polymer modification of concrete or cementations materials has been used successfully for durability enhancement for thousands of years (for example, The Great Wall of China). Although the modern literature is replete with examples of the use of natural and synthetic polymers in concrete, the volume of commercial polymer-modified concrete represents only a fraction of the total global concrete production. This is due to the high cost of the polymer and handling and performance problems.

An example of a commercially available polymer modified concrete is Dow Chemical's S/B latex modified concrete (LMC). Dow's S/B LMC is a specialty concrete with outstanding performance, specifically low permeability coupled with high abrasion resistance, toughness, and adhesion. However, because the S/B LMC is about 4-5 times the cost of standard concrete, it has always been limited to use in permeation control overlays on highway bridges and parking garage decks subjected to corrosive (high salt) environments.

The high cost of the S/B LMC is due both to the high latex loading requirement (about 15 weight percent, based on the weight of the cement) and the need for a special mobile on-site mixer. This special mixer which is considerably more costly than a Ready-Mix truck, is preferentially used because the poor slump stability of the S/B LMC during the extended mixing period in the Ready-Mix truck.

In an effort to solve the problem of Ready-Mix deliverability, high T_{g} (greater than 30° C) latexes have been developed. For example, in U.S. Pat. No. 5,576,378, Kuhlmann et al. describes the preparation and use of stable aqueous dispersions of polymers of styrene, α-methylstyrene, vinyltoluene, butadiene, isoprene, polymers of methacrylates and acrylates such as methylmethacrylate, methylacrylate, 2-hydroxyethylacrylate, and 2-ethylhexyl acrylate, and polymers of ethylenically unsaturated carboxylic acid monomers such as maleic acid, maleic anhydride, and methacrylic acid. Although these latexes are conducive to Ready-Mix deliverability, because of their high T_{g} they are not film-forming at processing temperatures. That is, the latexes do not form films at the temperatures at which the mortar or concrete are prepared, generally in the range of 10° C. to 40° C. Therefore, these high T_{g} latexes do not exhibit the desired low water permeability and bonding properties observed for S/B latexes.

Accordingly, it would be desirable to find a modifier that imparts similar properties to the concrete or mortar as the S/B latex, but with a lower loading requirement and a maintenance of slump as compared to the unmodified concrete or mortar, so that a less expensive Ready-Mix truck can be used to transport the modified mortar or concrete from the mixing site to the delivery site.

### SUMMARY OF THE INVENTION

The present invention addresses a need in the art by providing a composition comprising a mixture of a stable aqueous dispersion of a prepolymer or preformed polymer in concrete or mortar, wherein the prepolymer or preformed polymer is film-forming in the concrete or mortar at processing temperatures.

In a second aspect, the present invention is a composition comprising either a) a stable aqueous dispersion of an ethylene-vinyl ester copolymer in concrete or mortar; or b) a mixture of an ethylene-vinyl ester copolymer redispersable powder and concrete or mortar.

The composition of the present invention addresses a need in the art by providing a latex modified concrete that is Ready-Mix deliverable, and preferably a latex modified concrete that is film-forming at temperatures at which the mortar or concrete is processed, which is typically in the range of 10° C. to 40° C.

### DETAILED DESCRIPTION OF THE INVENTION

In one aspect, the composition of the present invention is a mixture of mortar or concrete and a stable aqueous dispersion of a preformed polymer having a T_{g} of preferably less than 20° C., more preferably less than 10° C., and most preferably less than 0° C. By virtue of having such low T_{g}s, the latexes tend to be, and preferably are film-forming at room temperature (that is, about 25° C.). Examples of suitable preformed polymers include epoxy resins, polyurethanes, and ethylene-C₃-C₂₀-α-olefins such as AFFINITY™ ethylene-1-octene copolymers (a trademark of The Dow Chemical Company).

The polyurethane dispersion preferably contains a nonionic surfactant, which is preferably incorporated into the polyurethane at the prepolymer stage by reacting from about 1 to 5 percent by weight of a polyethylene or polypropylene oxide monol with a diisocyanate and a polyol. The preparation of such a prepolymer and subsequent polyurethane dispersion is described in U.S. Pat. No. 5,959,027 starting at column 8 (Examples 2 and 3), which teachings are incorporated herein by reference.

The polyurethane dispersion is advantageously prepared in the presence of an anionic surfactant. The preferred concentration of the anionic surfactant is preferably from about 1 to about 3 weight percent, based on the weight of the dispersion. Examples of preferred classes of anionic surfactants include sulfates and sulfonates such as alkali metal and ammonium C₈-C₂₀-alkyl benzene sulfonates such as sodium dodecylbenzene sulfonate (commercially available as Rhodocal™ LDS-22 surfactant, a trademark of Rhone Poulenc); trialkanol amine C₈-C₂₀-alkyl sulfates such as triethanolamine lauryl sulfate (commercially available as DeSulf™ LTS-40 surfactant, a trademark of DeForrest Enterprise, Inc.); and trialkanolamine C₈-C₂₀-alkyl benzene sulfonates such as triethanolamine dodecylbenzene sulfonate (commercially available as DeSulform DBS-60T surfactant).

Though not bound by theory, it is believed that the addition of a stabilizing amount of a nonionic surfactant to the polyurethane latex is desired to prevent coagulation of the latex in the ionically charged mortar or concrete. Indeed, the presence of nonionic surfactants in latexes in general is desired to prevent such coagulation. The concentration of the additional nonionic surfactant is preferably from about 2 weight percent, more preferably from about 3 weight percent, and most preferably from about 5 weight percent, to about 10 weight percent, more preferably 8 weight percent, and most preferably 6 weight percent based on the weight of the solids content of the polyurethane latex. An example of a suitable nonionic stabilizer is di-sec-butylphenol-10-ethylene oxide.

The epoxy dispersion can be prepared by methods well known in the art and is preferably stabilized by a combination of nonionic surfactants that show stability at both low temperature and high temperature. The epoxy resin, from which the dispersion is prepared, is a monomeric or oligomeric polyglycidyl ether of a polyhydroxy hydrocarbon. This monomer or oligomer (either or which are considered prepolymers) can be prepared by reacting an epihalohydrin with a polyhydroxy hydrocarbon or a halogenated polyhydroxy hydrocarbon under such conditions to prepare the desired product. Such preparations are well known in the art. (See for example, U.S. Pat. No. 5,118,729, column 4). A preferred epoxy resin is a diglycidyl ether of Bisphenol A, an oligomer of diglycidyl ether of Bisphenol A.

The preferred low temperature nonionic surfactant is characterized by having a molecular weight of not less than 1,000 and not more than 7,000. Preferred low temperature nonionic surfactants are illustrated:

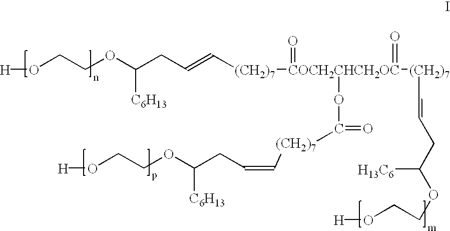

where the sum of n, m, and p in I is such that the molecular weight of I is not less than about 1000 Daltons, more preferably not less than about 2000 Daltons, and not more than about 7,000 Daltons, more preferably not more than about 5,000 Daltons. Commercially available Group I low temperature nonionic surfactants include Hydropalat 3037 nonionic surfactant (available from Henkel, n+m+p=40), Emulgin PRT 100 nonionic surfactant (available from Henkel, n+m+p=100), and Emulpon EL 42 nonionic surfactant (available from Witco, n+m+p=42);

CH₃(CH₂)ₓO(CH₂CH₂O)_{y}—H II

where x is from about 10 to 18, and where y is from about 30 to 50, more preferably from about 35 to about 45. A commercially available Group II low temperature nonionic surfactant is Disponil TA 430 nonionic surfactant (available from Henkel, x=C₁₁-C₁₇, y=40);

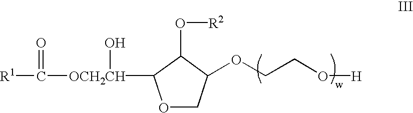

where R¹ is oleyl (9-octadecene-yl), and R² is either

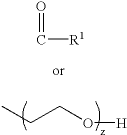

where the sum of w and z is not less than about 10, more preferably not less than about 15, and not greater than about 30, more preferably not greater than about 25. A commercially available Group III low temperature nonionic surfactant is Sorbanox AO nonionic surfactant (Witco), which is a mixture of the Group III structures.

The preferred high temperature nonionic surfactant is characterized by having a molecular weight of greater than 7,000 and not more than 20,000. Preferably, the high temperature nonionic surfactant has the following structure:

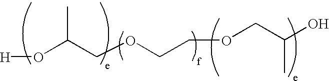

where each e is not less than about 10, preferably not less than about 15, most preferably not less than about 20, and not greater than about 50, more preferably not greater than 40, and most preferably not greater than 30; and f is not less than about 100, more preferably not less than about 200, and most preferably not less than about 250 ; and preferably not greater than about 500, more preferably not greater than about 400, and most preferably not greater than about 300. Examples of commercially available high temperature nonionic surfactants include Atsurf 108 surfactant (ICI) and Pluronic F108 surfactant (BASF Corp.), each with a molecular weight of about 14,000 (e=24; f=255).

Another preferred high temperature nonionic surfactant has the structure of the Group I nonionic surfactant, wherein the sum of n, m, and p is such that the molecular weight is greater than 7000 and less than 20,000 Daltons. An example of a commercially available high temperature nonionic surfactant is Emulgin PRT 200 nonionic surfactant (Henkel). Other examples of suitable high temperature nonionic surfactants included ethoxylated mono- or dialkyl phenols such as polyethylene glycol nonyl or dinonyl phenyl ethers. An example of a commercially available ethoxylated dialkyl phenyl ether is Igepal DM 970 FLK PEG-150 dinonyl phenyl ether (Rhone-Poulenc).

The weight-to-weight ratio of the low temperature nonionic surfactant to the high temperature nonionic surfactant is application dependent, and is preferably not less than about 1:3, more preferably not less than 1:2, and most preferably not less than 1.5:1, and preferably not greater than 3: 1, more preferably not greater than about 2: 1, and most preferably not greater than about 1.5:1.

Stable aqueous dispersions of an ethylene-C₃-C₂₀-α-olefin copolymer such as AFFINITY™ ethylene-1-octene copolymer can be prepared by merging two streams in two separate feed lines, one that contains an aqueous phase and one that contains an oil phase, in a high shear environment to form a high internal phase ratio emulsion, which can then be diluted by further addition of water. The oil phase typically contains a sufficient amount of solvent for the polymer, preferably from about 10 to about 30 percent for a 100 melt index copolymer, to allow the oil phase to flow through the feed line. Examples of suitable solvents include cyclohexane, toluene, and isopar. The feed lines are advantageously heat traced to a temperature of from about 50° C. to about 80° C. to facilitate flow of the oil phase through the feed line.

The ratio of the flow rates of the oil phase stream to the aqueous phase stream is somewhat dependent on the concentration and type of surfactant of surfactants used and is preferably not less than 10:1 and preferably not more than 20:1.

The dispersions are stablized with a surfactant that may be included in the oil phase or water phase or both phases, or which may be added to either stream or both streams using a separate feed line. Preferably, the surfactant or mixture of surfactants is combined with the copolymer in the oil phase stream. The surfactant, which is preferably nonionic, is more preferably a mixture of a high temperature nonionic surfactant (such as Pluronic F108 surfactant) and a low temperature nonionic surfactant (such as Disponil TA430 nonionic surfactant). Most preferably, an anionic surfactant (such as Rhodacal DSB anionic surfactant) is also included to lower the total amount of surfactant required to stabilize the dispersion.

The weight:weight ratio of the low temperature to the high temperature nonionic surfactants is preferably not less than about 1:3, more preferably not less than 1:2, and most preferably not less than 1.5:1, and preferably not greater than 3:1, more preferably not greater than about 2:1, and most preferably not greater than about 1.5:1. The weight:weight ratio of the total nonionic surfactant to the anionic surfactant is preferably not less than 5: 1, more preferably not less than 10: 1, and most preferably not less than 15: 1, and preferably not more than 50:1, more preferably not more than 25:1. The concentration of total surfactant in the latex is preferably not less than 2, and more preferably not more than 4 weight percent, and preferably not more than 8, more preferably not more than 6 weight percent, based on the solids content of the stable aqueous dispersion.

The solids content of the stable aqueous dispersion of the ethylene-C₃-C₂₀-α-olefin copolymer is preferably adjusted to 40 to 60 weight percent.

In this first aspect of the present invention, the stable aqueous dispersions are specifically of prepolymers or preformed polymers, that is, latexes that cannot be prepared by standard emulsion polymerization techniques. Thus, an S/B latex, which is prepared by emulsion polymerization, is not a stable aqueous dispersion of a prepolymer or a preformed polymer.

In another aspect, the present invention is a composition comprising either a) a stable aqueous dispersion of an ethylene-vinyl ester copolymer, preferably an ethylene-vinyl acetate (EVA) copolymer in concrete or mortar; or b) a mixture of an ethylene-vinyl ester copolymer, preferably an EVA copolymer redispersable powder and concrete or mortar. Stable aqueous dispersions of ethylene-vinyl ester copolymers, particularly EVA copolymers and the redispersable powders made therefrom are well known in the art and are described, for example in U.S. Pat. No. 3,883,489, which description is incorporated herein by reference. Examples of commercially available EVA copolymer dispersions include Airflex™ 526 BP and Airflex™ 528 BP (a trademark of Air Products and Chemicals Inc.)

As is the case for polyurethane, it is desirable to add a sufficient amount of a nonionic surfactant to the EVA copolymer dispersion to prevent coagulation of the latex in the mortar or concrete. Alternatively, if the EVA powder is used, a stabilizing amount of the nonionic surfactant is advantageously added to the water that is used in the latex and concrete or mortar formulation.

In general, some amount of anionic surfactant is desired to prepare a stable aqueous dispersion since dispersions prepared only with nonionic surfactants tend to require high concentrations of surfactant to remain stable, and it is desirable to minimize the concentration of surfactant required to impart stability to the dispersion.

On the other hand, the presence of too much anionic surfactant may cause undesirable air entrainment in the final latex modified concrete. For this reason, it is desirable to find a balance of anionic surfactant that reduces the total surfactant concentration in the stable aqueous dispersion without causing too much air entrainment. This balance is application dependent and can be determined by one of ordinary skill in the art without undue experimentation. In general, the concentration of the anionic surfactant is not greater than 3 weight percent, more preferably not more than 2 weight percent, and most preferably not greater than 1 weight percent, based on the weight of the solids content of the latex. However, useful latexes can be prepared using less than 0.1 weight percent anionic surfactant.

The preferred solids content of the latex is at least 30, more preferably at least 40, and most preferably at least 50 weight percent, based on the weight of the water and the disperse phase.

The concentration of the stable aqueous dispersion of the preformed polymer in the mortar or concrete is the lowest amount necessary to achieve the desired water permeability, bonding, and slump stability in the modified concrete or mortar, and is preferably not greater than 20 weight percent, more preferably not greater than 15 weight percent, and most preferably not greater than 10 weight percent; and not less than 1 weight percent, more preferably not less than 3 weight percent, and most preferably not less than 5 weight percent, based on the weight of the stable aqueous dispersion and the mortar or concrete.

The following examples are for illustrative purposes only and are not intended to limit the scope of this invention.

### EXAMPLE 1

### Modification of Concrete with 1-Type Epoxy Latex

Sand (2NS, 30,333 g) and coarse aggregate (25A, 24,863 g) were dry mixed in a concrete mixer until the mixture became visually uniform. Cement (Holnam Type 1, 12,000 g) was added and dry mixed until the mixture became visually uniform. XZ 92500 epoxy dispersion (a dispersion of D.E.R. 661, 1763 g wet, 51% solids loading, available from The Dow Chemical Company) was added, followed by high range Daxad 19LCA dispersant (149.8 g, 40% active, available from Hampshire Chemical), and Dow Corning silicone emulsion 1520 defoamer (57.5 g, 20% active). The blend was mixed for 1 minute at 19 rpm. The mixer was turned off and after another minute, mixing was resumed for 3 minutes.

After mixing, slump and air content were measured. The slump of the mixture was found to be 10 inches (25.4 cm, ASTM C-143) and the air content was found to be 2.6% of the mixture volume (ASTM C-231).

The concrete mix was cast into nine 3″×6″ (7.6-cm×15.2-cm) cylinders for compressive strength measurements, three 4″×8″ (10.2-cm×20.3-cm) for chlorine ion conductivity measurements (ASTM C-1202), and three 4″×4″×14″ (10.2-cm×10.2-cm×35.6-cm) bars for flexural strength measurements of the cured concrete. After casting, the specimens were mechanically vibrated for 30 seconds to ensure complete filling of molds. The specimens were then covered with damp burlap and a plastic sheet to prevent evaporative water loss. After curing for 24 hours, samples were removed from their molds and transferred to a constant temperature room and cured further for subsequent testing.

The average compressive strength of three 1-day cured samples was 4487 psi (31.0 MPa); for three 7-day cured samples, the average compressive strength was 7704 psi (53.2 MPa), and for three 28-day cured samples it was 9200 psi (63.5 MPa). The average 28-day cured bend strength for three samples was 842 psi (5.8 MPa). The average chloride ion conductivity for two 28-day cured samples was 2003 Coulombs and the average chloride ion conductivity for two 90-day cured samples was 1000 Coulombs.

### EXAMPLE 2

### Modification of Concrete with Polyurethane Dispersion

The general procedure described in Example 1 was used with the modifications shown in Table 1. The polyurethane dispersion was prepared as described in U.S. Pat. No. 6,087,440, column 6, beginning at line 18, which description is incorporated herein by reference.

TABLE 1

| Ingredient | Quantity |
|---|---|
| 2NS sand | 754.4 Kg |
| 25 A aggregate | 618.4 Kg |
| Holnam type 1 cement | 298.5 Kg |
| polyurethane dispersion | 38.7 Kg |
| high range water reducer (dispersant) | 3.7 Kg |
| defoamer | 0.2 Kg |
| water | 756.6 L |

The polyurethane dispersion had a solids content of 57.8% and was pre-stabilized with PG36 (di-sec-butylphenol-10-ethylene oxide) at 5.75% of dispersion solid. The slump was 9.75 inches (24.8 cm) and the air content 2.7%.

The average compressive strength of three 1-day cured samples was 4211 psi (29.1 MPa), the average compressive strength of three 7-day cured samples was 5893 psi (40.7 MPa), and the average compressive strength of three 28-day cured samples was 7172 psi (49.5 MPa). The average bend strength for three 28-day cured samples was 749 psi (5.2 MPa). The average chlorine ion conductivity for two 28-day cured samples was 1792 Coulombs and the average conductivity for two 90-day cured samples was 730 Coulombs.

What is claimed is:

1. A composition comprising a stable aqueous dispersion of a prepolymer or preformed polymer in concrete or mortar wherein the prepolymer or preformed polymer is film-forming in the concrete or mortar at processing temperatures.

2. The composition of claim 1 wherein the preformed polymer has a T_{g} of less than 20° C.

3. The composition of claim 1 wherein the prepolymer or preformed polymer is an epoxy resin, a polyurethane resin, or an ethylene-C₃-C₂₀-α-olefin copolymer.

4. The composition of claim 3 wherein the prepolymer is an epoxy resin.

5. The composition of claim 3 wherein the prepolymer or preformed polymer is a polyurethane.

6. The composition of claim 3 wherein the preformed polymer is an ethylene-1-octene copolymer.

7. The composition of claim 1 wherein the dispersion contains a sufficient amount of a nonionic surfactant to prevent coagulation of the dispersion in the mortar or concrete and not more than 3 weight percent of an anionic or cationic surfactant, based on the weight of the solids content of the dispersion.

8. A composition comprising either a) a stable aqueous dispersion of an ethylene-vinyl ester copolymer in concrete or mortar; or b) a mixture of an ethylene-vinyl ester copolymer redispersable powder and concrete or mortar.

9. The composition of claim 8 which comprises a stable aqueous dispersion of an ethylene-vinyl acetate copolymer in concrete or mortar, wherein the dispersion contains a sufficient amount of a nonionic surfactant to prevent coagulation of the dispersion in the mortar or concrete.

10. The composition of claim 8 which comprises a mixture of an ethylene-vinyl acetate copolymer redispersable powder and concrete or mortar and water that contains a sufficient amount of a nonionic surfactant to prevent coagulation of the dispersion in the mortar or concrete.
